(19) United States
(12) Patent Application Publication
(10) Pub. No.: US 2008/0127425 A1
(43) Pub. Date: Jun. 5, 2008

(54) MULTI-FUNCTIONAL TOOL

(76) Inventor: Hsine-Jui Chen, Daya Shiang (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/565,759

(22) Filed: Dec. 1, 2006

(51) Int. Cl. B25F 1/00; B25B 23/00; B26B 11/00

(52) U.S. Cl. 7/100; 81/57.44; 7/158

(57) ABSTRACT

A tool assembly is provided for mending a puncture in a tire. The tool assembly includes a needle and a power tool. The needle includes a diverged tip for carrying a patch for mending the puncture and a connective end. The power tool includes a driving element for releasable engagement with the connective end of the bit so that the power tool can drive the bit.

### BACKGROUND OF INVENTION

1. Field of Invention

The present invention relates to a multi-functional tool and, more particularly, to a multi-functional tool for conducting various tasks such as mending a puncture and driving a screwdriver.

2. Related Prior Art

In early days, to mend a puncture in a tire, a T-shaped hand tool to force a patch into the tire through the puncture and pulled the T-shaped hand tool from the tire, thus leaving the patch in the puncture. It is however difficult for a user to force the T-shaped hand tool into and from a thick tire often used for a truck or any other heavy-duty vehicle.

To avoid the foregoing drawback, the inventor and applicant of the present invention has devised a power tool for mending a puncture. The power tool includes a body 10 formed with a handle 11 and a primary barrel 12. An extensive barrel 20 is engaged with the primary barrel 12 after a valve 50 and a hammer 40 are disposed therein. A needle 2 is formed with a shank 2B and a diverged tip 2A. An end of an elastic element 30 is secured to the shank 2B while another end of the elastic element 30 is secured to the extensive barrel 20. The shank 2B is partially inserted into the extensive barrel 12 so that the shank 2B can be hit and moved by the hammer 40. The diverged tip 2A is used to carry a patch. This power tool is effective in mending a puncture; however, it is good for nothing else. Therefore, a user has to carry another tool if wishing to conduct another task such as driving a threaded bolt or nut. This is an inconvenient and expensive practice.

### SUMMARY OF INVENTION

According to the present invention, a tool assembly is provided for mending a puncture in a tire. The tool assembly includes a needle and a power tool. The needle includes a diverged tip for carrying a patch for mending the puncture and a connective end. The power tool includes a driving element for releasable engagement with the connective end of the bit so that the power tool can drive the bit.

The primary advantage of the tool assembly according to the present invention is the possibility of using another bit with the power tool since the connective end of the needle is engaged with the driving element of the power tool in a releasable manner.

Other advantages and features of the present invention will become apparent from the following description referring to the drawings.

### BRIEF DESCRIPTION OF DRAWINGS

The present invention will be described through detailed illustration of three embodiments referring to the drawings.

FIG. 1 is a perspective view of a bit in the form of a needle used with a power tool according to the first embodiment of the present invention.

FIG. 2 is a cross-sectional view of the power tool shown in FIG. 1.

FIG. 3 is a cross-sectional view of the power tool in another position than shown in FIG. 2.

FIG. 4 is a perspective view of a bit in the form of a screwdriver used with the power tool shown in FIG. 1.

FIG. 5 is a perspective view of a power tool according to the second embodiment of the present invention.

FIG. 6 is a perspective view of a power tool according to the third embodiment of the present invention.

### DETAILED DESCRIPTION OF EMBODIMENTS

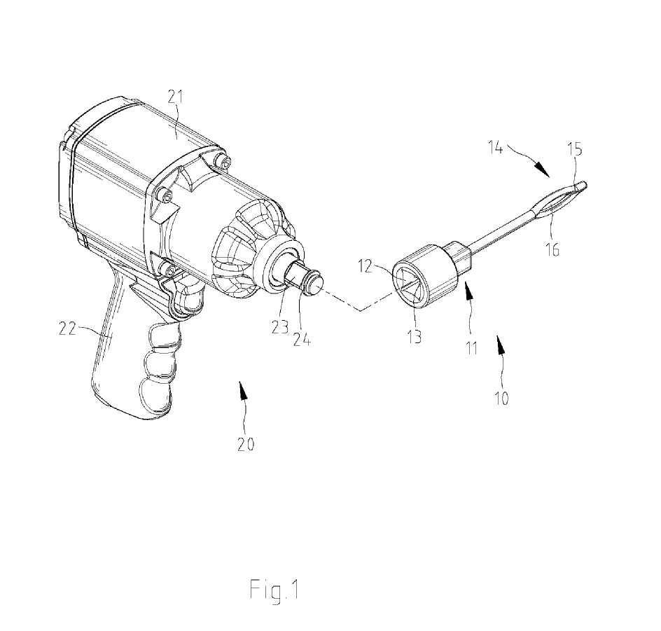

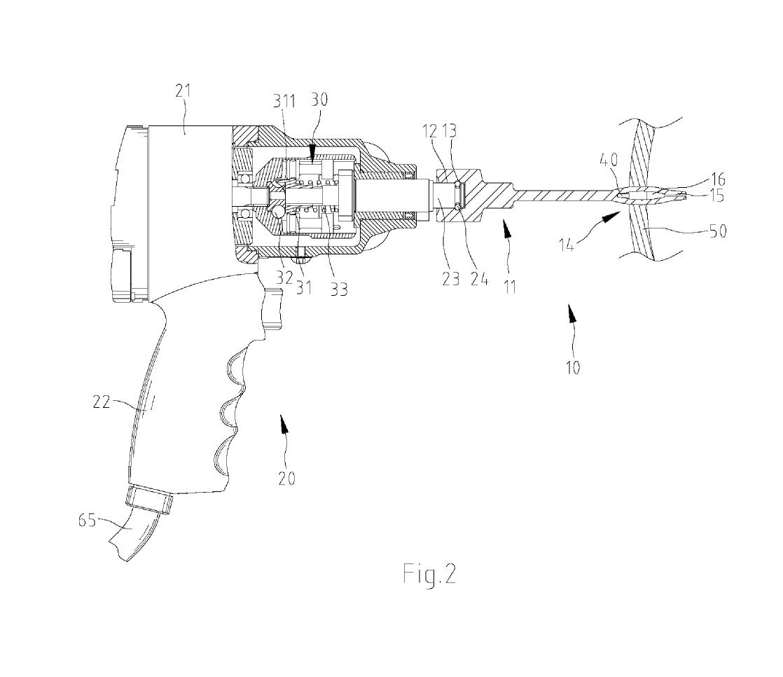

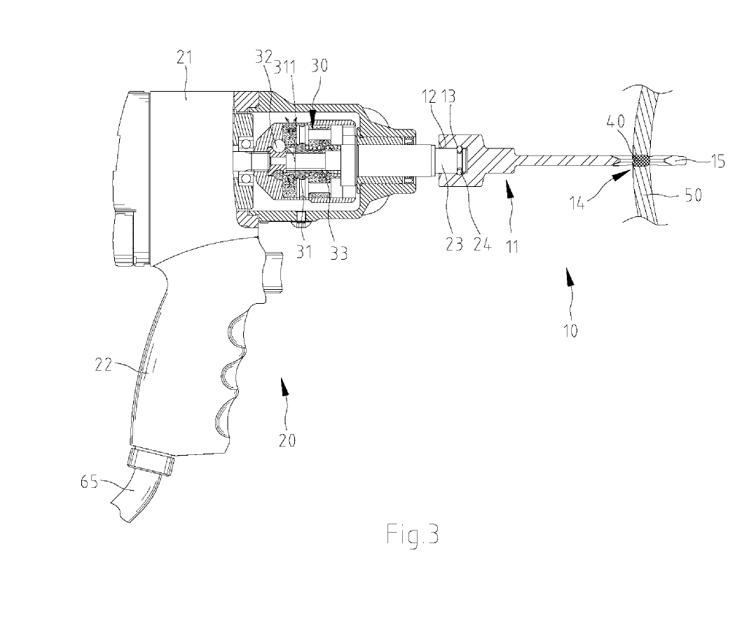

Referring to FIGS. 1 through 3, a bit 10 is used with a power tool 20 according to a first embodiment of the present invention.

The bit 10 is in the form of a needle for mending a puncture. The needle 10 includes a socket 12 at an end 11 and a diverged tip 15 at an opposite end 14. A first engagement device 13 is disposed in the socket 12. In the first embodiment, the first engagement device 13 is a plurality of recesses in an internal side of the socket 12. The diverged tip 15 is used to carry a patch 40 into a tire 50 through a puncture in the tire 50. The diverged tip 15 defines a split 1 6 for receiving the patch 40.

The power tool 20 includes a barrel 21 and a handle 22 extended from the barrel 21. A power mechanism 30 is disposed in the barrel 21. The power mechanism 30 is used for rotating and reciprocating the bit 10. The term “reciprocating” means moving the bit 10 to and fro along a rectilinear path. The power mechanism 30 includes an axle 31, a ball 32 and an elastic element 33. The axle 31 includes a slope 311 at an end for sliding on the ball 32. When actuated, the axle 31 rotates the ball 32 while the ball 32 pushes the axle 30. The elastic element 33 is used to return the axle 30.

In the first embodiment, the power mechanism 30 is a pneumatic power mechanism. Therefore, a pipe 65 is connected to the power mechanism 30 so that the axle 31 can be energized by pressurized air from a pump through the pipe 65.

A driving element 23 is connected to another end of the axle 31. A second engagement device 24 is mounted on the driving element 23. In this embodiment, the second engagement device 24 is a C-clip 24 for insertion in the recesses 13 when the driving element 23 is inserted in the socket 12.

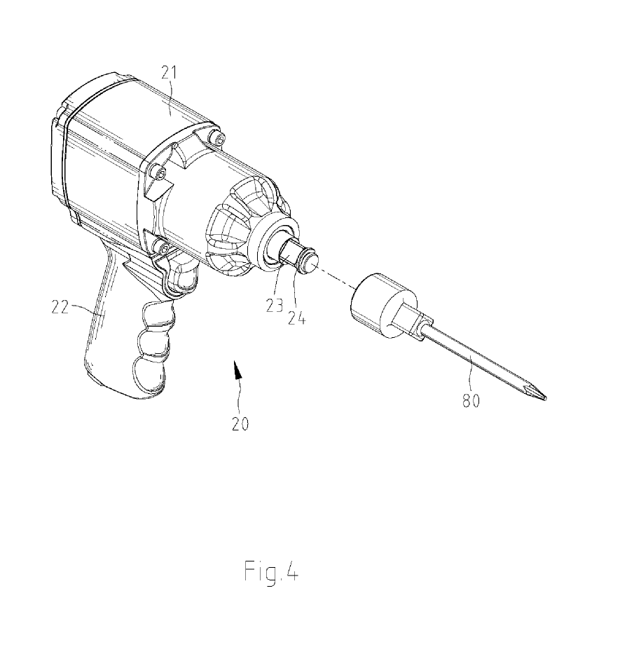

Referring to FIG. 4, another bit 80 is used with the power tool 20. The bit 80 is in the form of a screwdriver.

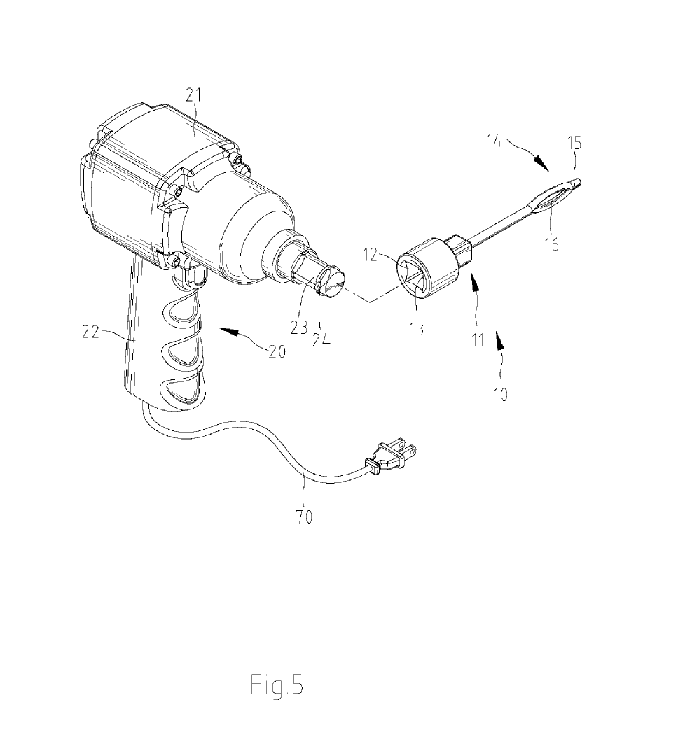

Referring to FIG. 5, there is shown a power tool according to a second embodiment of the present invention. The second embodiment is like the first embodiment except the power mechanism 30 is an electric power mechanism. Therefore, an electric cord 70 is connected to the power mechanism 30 so that the axle 31 can be energized by electricity from the mains through the electric cord 70.

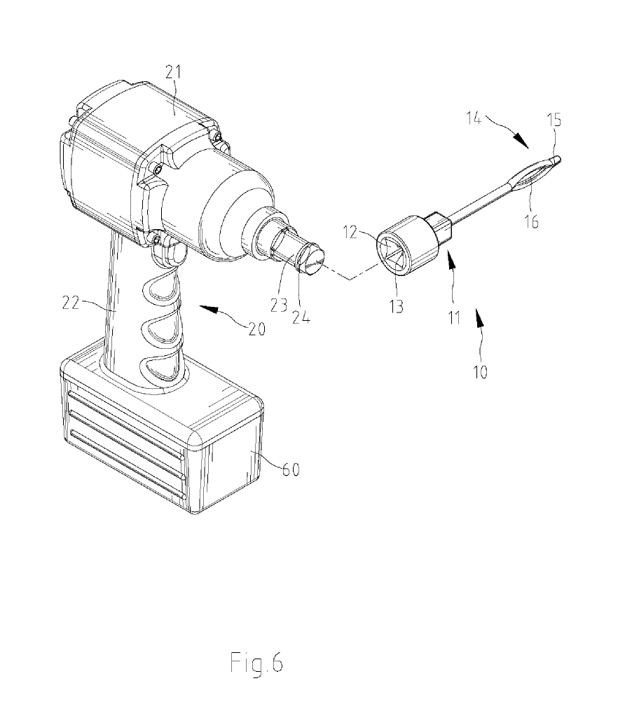

Referring to FIG. 6, there is shown a power tool according to a third embodiment of the present invention. The third embodiment is like the second embodiment except including a battery pack 60 instead of the electric cord 70.

The power tool according to the present invention exhibits several advantages. Firstly, it is multi-functional so that it can be used to mend a puncture and drive a threaded bolt or nut for example. Secondly, it can be energized by difference energy sources such as pressurized air, alternative current and direct current.

The present invention has been described through the illustration of the embodiments. Those skilled in the art can derive variations from the embodiments without departing from the scope of the present invention. Therefore, the embodiments shall not limit the scope of the present invention defined in the claims.

What is claimed is:

1. A tool assembly for mending a puncture in a tire, the tool assembly comprising:
a needle comprising a diverged tip for carrying a patch for mending the puncture and a connective end; and
a power tool comprising a driving element for releasable engagement with the connective end of the bit so that the power tool can drive the bit.

2. The tool assembly according to claim 1 wherein the needle comprises a socket at the connective end for receiving the driving element.

3. The tool assembly according to claim 2 wherein the bit comprises a first engagement device disposed in the socket while the power tool comprises a second engagement device mounted on the driving element for engagement with the first engagement device.

4. The tool assembly according to claim 3 wherein the first engagement device includes a plurality of recesses while the second engagement device includes a C-ring for fitting in the plurality of recesses.

5. The tool assembly according to claim 1 wherein the power tool comprises a power mechanism for rotating and reciprocating the driving element.

6. The tool assembly according to claim 5 wherein the power mechanism comprises:
an axle formed with a slope;
a ball in contact with the slope of the axle so that the ball pushes the axle while the axle rotates the ball; and
an elastic element for keeping the axle in contact with the ball.

7. The tool assembly according to claim 6 wherein the axle is energized by pressurized air.

8. The tool assembly according to claim 7 comprising a tube for transferring the pressurized air to the axle.

9. The tool assembly according to claim 6 wherein the axle is energized by electricity.

10. The tool assembly according to claim 9 comprising an electric cord to transfer the electricity to the axle from the mains.

11. The tool assembly according to claim 9 comprising a battery pack for providing the electricity.

12. A needle comprising:
a diverged tip for carrying a patch for mending a puncture in a tire a socket formed opposite to the diverged tip and used for receiving a driving element; and
an engagement device disposed in the socket and used for engagement with the driving element.

13. The tool assembly according to claim 12 wherein the engagement device includes a plurality of recesses.
